(19) United States
(12) Patent Application Publication
(10) Pub. No.: US 2007/0054836 A1
(43) Pub. Date: Mar. 8, 2007

(54) 3-Isopropyl-1-methylcyclopentyl derivatives and their use in fragrance applications

(76) Inventor: Jerzy A. Bajgrowicz, Zurich (CH)

Correspondence Address: CURATOLO SIDOTI CO., LPA, 24500 CENTER RIDGE ROAD, SUITE 280, CLEVELAND, OH, 44145, US

(21) Appl. No.: 10/572,804

(22) PCT Filed: Sep. 29, 2004
(86) PCT No.: PCT/CH04/00604

§ 371 Date: Aug. 24, 2006

(30) Foreign Application Priority Data
Sep. 30, 2003 (GB) 0322750.1

(51) Int. Cl. A61Q 13/00

(52) U.S. Cl. 512/1

(57) ABSTRACT

This invention relates to -3-isopropyl-1-methylcyclopentyl derivatives of formula (Ia) and (Ib), where R¹, R², and R³ are as defined in the claims, and their use in fragrance applications.

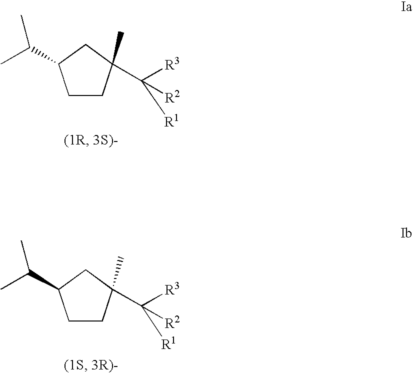

The present invention relates to 3-isopropyl-1-methylcyclopentyl derivatives, namely (3-isopropyl-1-methylcyclopentyl)ethanol, (3-isopropyl-1-methylcyclopentyl)ethanone and (3-isopropyl-1-methylcyclopentyl)methanol and their use as fragrances. This invention relates furthermore to a method for their production and to fragrance compositions comprising them.

In the fragrance industry there is a constant demand for new compounds that enhance or improve on odour notes, or impart new odour notes.

It has now been found that certain 3-isopropyl-1-methylcyclopentyl derivatives have much sought-after floral, fruity and woody odour notes, and they are relatively simple and easy to prepare starting from naturally available (1S)-(+)- and (1R)-(-)-fenchone.

Accordingly, the present invention refers in one of its aspects to the use of a compound of formula Ia and the enantiomer, namely (1S,3R)- enantiomer, thereof as fragrance 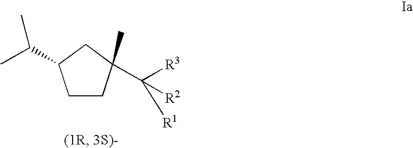
wherein

R¹ is hydrogen or methyl;

R² is hydrogen; and

R³ is hydroxyl; or

R² and R³ form together with the carbon atom to which they are attached a carbonyl group.

It has been found that the odour threshold of certain compounds of formula Ia is on an average two times lower than that of the corresponding enantiomer. Accordingly, a compound of formula I 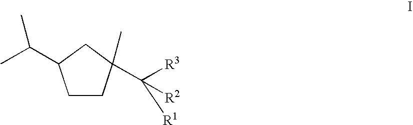
enriched in its (1R,3S) enantiomer of formula la are preferred.

The term “enriched” is used herein to describe a compound having an enantiomeric purity greater than 1:1 in favour of the selected enantiomer. Compounds are preferred having a purity of about 1:3 or greater, e.g. 1:4. Particularly preferred are compounds having an enantiomeric purity of 1:9 or greater, such as 5:95 or 1:99.

Particularly preferred compounds of the present invention are [(1R,3S)-3-isopropyl-1-methylcyclopentyl]methanol, 1-[(1R,3S)-3-isopropyl-1-methylcyclopentyl]ethanone, and 1-[(1R,3S)-3-isopropyl-1-methylcyclopentyl]ethanol.

The compounds according to the present invention may be used alone or in combination with a base material. As used herein, the “base material” includes all known odourant molecules selected from the extensive range of natural products and synthetic molecules currently available, such as essential oils, alcohols, aldehydes and ketones, ethers and acetals, esters and lactones, macrocycles and heterocycles, and/or in admixture with one or more ingredients or excipients conventionally used in conjunction with odourants in fragrance compositions, for example, carrier materials, and other auxiliary agents commonly used in the art.

The following list comprises examples of known odourant molecules, which may be combined with the compounds of the present invention:
ethereal oils and extracts, e.g. tree moss absolute, basil oil, castoreum, costus root oil, myrtle oil, oak moss absolute, geranium oil, jasmin absolute, patchouli oil, rose oil, sandalwood oil, wormwood oil, lavender oil or ylang-ylang oil;
alcohols, e.g. citronellol, Ebanol™, eugenol, farnesol, geraniol, Super Mugue™, linalool, phenylethyl alcohol, Sandalore™, terpineol or Timberol™.
aldehydes and ketones, e.g. α-amylcinnamaldehyde, Georgywood™, hydroxycitronellal, Iso E Super®, Isoraldeine®, Hedione®, maltol, Methyl cedryl ketone, methylionone or vanillin;
ethers and acetals, e.g. Ambrox™., geranyl methyl ether, rose oxide or Spirambrene™.
esters and lactones, e.g. benzyl acetate, Cedryl acetate, γ-decalactone, Helvetolide®, γ-undecalactone or Vetivenyl acetate.
macrocycles, e.g. Ambrettolide, Ethylene brassylate or Exaltolide®.
heterocycles, e.g. isobutylchinoline.

The compounds of the present invention may be used in a broad range of fragrance applications, e.g. in any field of fine and functional perfumery, such as perfumes, household products, laundry products, body care products and cosmetics. The compounds can be employed in widely varying amounts, depending upon the specific application and on the nature and quantity of other odourant ingredients. The proportion is typically from 0.001 to 20 weight percent of the application. In one embodiment, compounds of the present invention may be employed in a fabric softener in an amount of from 0.001 to 0.05 weight percent. In another embodiment, compounds of the present invention may be used in fine perfumery in amounts of from 0.1 to 20 weight percent, more preferably between 0.1 and 5 weight percent. However, these values are given only by way of example, since the experienced perfumer may also achieve effects or may create novel accords with lower or higher concentrations.

The compounds of the present invention may be employed into the fragrance application simply by directly mixing the fragrance composition with the fragrance application, or they may, in an earlier step be entrapped with an entrapment material, for example, polymers, capsules, microcapsules and nanocapsules, liposomes, film formers, absorbents such as carbon or zeolites, cyclic oligosaccharides and mixtures thereof, or they may be chemically bonded to substrates, which are adapted to release the fragrance molecule upon application of an external stimulus such as light, enzyme, or the like, and then mixed with the application.

Thus, the invention additionally provides a method of manufacturing a fragrance application, comprising the incorporation of a compound of formula I enriched in one of their enantiomers, as a fragrance ingredient, either by directly admixing the compound to the application or by admixing a fragrance composition comprising a compound of formula I enriched in one of their enantiomers, which may then be mixed to a fragrance application, using conventional techniques and methods.

As used herein, “fragrance application” means any product, such as fine perfumery, e.g. perfume and eau de toilette; household products, e.g. detergents for dishwasher, surface cleaner; laundry products, e.g. softener, bleach, detergent; body care products, e.g. shampoo, shower gel; and cosmetics, e.g. deodorant, vanishing creme, comprising an odourant. This list of products is given by way of illustration and is not to be regarded as being in anyway limiting.

Compared to most odorant molecules known in the art having floral odor properties, such as hydroxycitronellal, geranol, linalool and 4-(4-hydroxy-4-methylpentyl)cyclohex-3-ene-1-carbaldehyde, the compounds of formula Ia of the present invention, wherein R³ is hydroxyl, are exceptionally stable both, under basic and acidic conditions, thus making them particularly useful for a large variety of fragrance applications.

Compounds of formula Ia and the enantiomers thereof may be prepared by the Haller-Bauer rearrangement of (1R)-(-)-fenchone/(1S)-(+)-fenchone (1,3,3-trimethyl-2-norbornanone) followed by hydrolysis to 3-isopropyl-1-methylcyclopentanecarboxylic acid under alkali conditions, e.g. in the presence of a base such as NaOH or KOH. The resulting acid will then be reacted with methyllithium to give a compound of formula I wherein R² and R³ form together with the carbon atom to which they are attached a carbonyl group. To give further compounds of the present invention, the resulting ketone may be transformed to a secondary alcohol through reduction, e.g. with NaBH₄.

(3-Isopropyl-1-methylcyclopentyl)methanol may be prepared by reduction of 3-isopropyl-1-methylcyclopentanecarboxylic acid (A), which has been prepared by rearrangement of fenchone, in the presence of LAH to the corresponding alcohol, as shown in scheme 1.

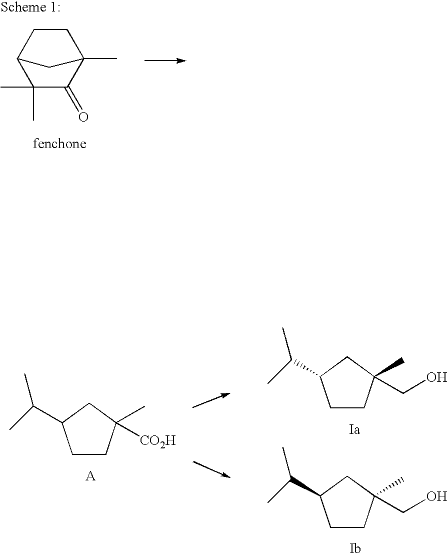

Optically pure compounds of formula Ia and Ib and enantiomeric mixtures of a compound of formula I enriched in one of the enantiomers, i.e. a compound of formula Ia or Ib, may be synthesised, starting from optically pure fenchone or an enantiomeric mixture enriched in either (1R)-(-)-fenchone or (1S)-(+)-fenchone.

The invention is now further described with reference to the following non-limiting examples.

All end products described in the following Examples 1 to 6 are colourless oils. They were obtained starting from (1R)-(-)- and (1S)-(+)-fenchone that contained 8% and 2% respectively of the other entantiomer. The reported NMR data were measured under the following general conditions: ¹H at 400 and ¹³C at 100 MHz; in CDCl₃; chemical shifts (δ) in ppm downfield from TMS; coupling constants J in Hz.

### EXAMPLE 1

### [(1R,3S)-3-Isopropyl-1-methylcyclopentyl]methanol

A solution of (1R,3S)-3-Isopropyl-1-methylcyclopentanecarboxylic acid (70.0 g, 0.41 mol), obtained from (1R)-(-)-fenchone (V. Braun, J.; Jacob, A. Chem. Ber. 1933, 66, 1461) in diethyl ether (100 ml) was slowly added, under nitrogen, to a suspension of lithium aluminium hydride (13.3 g, 0.35 mol) in the same solvent (500 ml). After heating at reflux during 3 h, the reaction mixture was cooled down to 10° C., 2N NaOH solution (70 ml) was carefully added and stirring continued for 0.5 h. The white solid was filtered off, the filtrate washed with brine (2×500 ml), dried (MgSO₄) and concentrated in vacuo, The crude product (79.0 g) was purified by distillation using a 10 cm Vigreux column (0.9-1.1 mbar, 96-98° C.) to give [(1R,3S)-3-isopropyl-1-methylcyclopentyl]methanol (57.0 g, 90% yield).

¹H-NMR: δ0.87 (d, J=6.7, 3H), 0.88 (d, J=6.7, 3H), 1.01 (s, 3H), 1.08 (dd, J=12.3, 11.0, 1H), 1.16-1.38 (m, 3H), 1.48 (ddd, J=12.4, 6.9, 0.8, 1H), 1.53-1.72 (m, 3H), 1.74-1.87 (m, 1H), 3.35 (d, J_{AB}=10.4, 1H), 3.39 (d, J_{AB}=10.4, 1H). ¹³C-NMR: δ21.5 (2q), 25.0 (q), 30.4 (t), 33.8 (d), 35.6 (t), 41.5 (t) 43.8 (s), 46.9 (d), 72.1 (t). [α]²²_{D} −12.0 (c 1.0, EtOH).

Odour description: floral, green, jasmine, lily-of-the-valley, fresh, clean.

### EXAMPLE 2

### [(1S,3R)-3-Isopropyl-1-methylcyclopentyl]methanol

Prepared according to the experimental procedure of Example 1 starting from (1S)-(+)-fenchone.

[α]²²_{D} +13.5 (c 1.0, EtOH).

Odour description: floral, fruity, green, rosy, hesperidic (grapefruit).

### EXAMPLE 3

### 1-[(1R 3S )-3-Isopropyl-1-methylcyclopentyl]ethanone

A 1.6 M solution of methyllithium in diethyl ether (200 ml, 0.32 mol) was added dropwise during 25 min. into a solution of (1R,3S)-3-Isopropyl-1-methylcyclopentanecarboxylic acid (25.5 g, 0.15 mol) in THF (250 ml) at 0° C. After stirring at 0° C. for 3 h, chlorotrimethylsilane (151 ml, 1.2 mol) was added with cooling and the reaction mixture was allowed to warm up to room temperature, poured on ice-cold water (200 ml), stirred for 0.5 h and extracted with MTBE (2×250 ml). The combined organic phases were washed with water (200 ml), 2M NaOH (150 ml) and brine (3×200 ml), dried (MgSO₄) and concentrated in vacuo to give the crude 1-[(1R,3S)-3-isopropyl-1-methylcyclopentyl]ethanone (27.6 g), a sample of which (1.5 g) was purified by bulb-to-bulb distillation (0.93 g, 68% yield).

¹H-NMR: δ0.89 (2d, J=6.6, 6H), 1.19 (s, 3H), 1.24 (dq, J=12.4, 9.1, 1H), 1.34-1.43 (m, 2H), 1.56-1.77 (m, 3H), 1.81-1.90 (m, 1H), 2.09 (ddd, J=13.1, 9.1, 4.0, 1H), 2.15 (s, 3H). ¹³C-NMR: δ21.3 (q), 21.4 (q), 25.0 (q), 25.3 (q), 30.2 (t), 33.3 (d), 35.6 (t), 41.0 (t), 46.6 (d), 55.3 (s), 213.0 (s). [a]²³_{D} −1.0 (c 1.1, EtOH).

Odour description: earthy/mossy, green, woody.

### EXAMPLE 4

### 1-(1S,3R)-3-Isopropyl-1-methylcyclopentyl]ethanone

Prepared according to the experimental procedure of Example 3 starting from (1S)-(+)-fenchone.

[a]²²_{D} +1.0 (c 1.1, EtOH).

Odour description: floral, agrestic, fruity, green.

### EXAMPLE 5

### 1 -(1R,3S) -3-Isopropyl-1-methylcyclopentyl]ethanol

A solution of 1-[(1R,3S)-3-isopropyl-1-methylcyclopentyl]ethanone from Example 3 (3.0 g, 18 mmol) in ethanol (8 ml) was added to a cold (ice-bath) solution of sodium borohydride (0.42 g, 10.7 mmol) in the same solvent (17 ml). After 1.5 h stirring at room temperature, the reaction mixture was poured on ice-cold 2M HCl (100 ml) and extracted with MTBE (2×100 ml). The combined organic phases were washed with brine (2×50 ml), dried (MgSO₄) and concentrated in vacuo. The crude product (2.8 g) was purified by bulb-to-bulb distillation (2.34 g, 77% yield, diastereoisomer ratio ˜1:1).

¹H-NMR: δ0.87 (d, J=6.6, 3H), 0.875 (d, J=6.6, 3H), 0.88 (2d, J=6.6, 6H), 0.92 (s, 3H), 0.93 (s, 3H), 1.05 (t, J=11.7, 1H), 1.12 (d, J=6.4, 3H), 1.125 (d, J=6.4, 3H), 1.14 (t, J=11.8, 1H), 1.17-1.74 (m, 12H), 1.47 (2s, 2H), 1.78-1.88 (m, 2H), 3.53 (q, J=6.3, 1H), 3.55 (q, J=6.3, 1H). ¹³C-NMR: δ18.5 (2q), 21.3 (2q), 21.4 (3q), 21.5 (q), 29.8 (t), 30.0 (t), 33.7 (2d), 35.8 (t), 35.9 (t), 41.9 (2t), 46.3 (2d), 46.8 (s), 46.9 (s), 75.4 (d), 75.7 (d). [a]²²_{D} −7.0 (c 1.0, EtOH).

Odour description: floral, earthy/mossy, slightly terpineol/earthy.

### EXAMPLE 6

### 1-(1S,3R)-3-Isopropyl-1-methylcyclopentyl]ethanol

Prepared according to the experimental procedure of Example 5 starting from (1S)-(+)-fenchone.

[a]²²_{D}+8.0 (c 1.0, EtOH).

Odour description: hesperidic/citrus, fruity, green, fresh (grapefruit, rhubarb).

### EXAMPLE 7

### Feminine Fine Fragrance

| Ingredient* | Parts per weight |
|---|---|
| Citronellol | 50 |
| Cyclamen aldehyde | 15 |
| Diethyl malonate | 5 |
| Dipropylene glycol (DPG) | 149 |
| Florhydral | 12 |
| Gardenol | 10 |
| Geraniol | 50 |
| Hedione | 25 |
| alpha-Hexylcinnamaldehyde | 200 |
| Hydroxycitronellal | 35 |
| Isocyclocitral 1% in DPG | 15 |
| Isojasmone | 2 |
| Jasmal | 40 |
| Jasmonyl | 20 |
| Lemon oil | 10 |
| Lilial | 25 |
| Linalool | 65 |
| Linalyl acetate | 50 |
| Methyl diantilis | 2 |
| Petitgrain Paraguay oil | 5 |
| Phenethyl alcohol | 65 |
| Silvial | 100 |
| [(1R,3S)-3-Isopropyl-1-methylcyclopentyl]methanol | 50 |
| Total | 1000 |

*for chemical names see Flavor and Fragrance Materials - 2003, Allured Publishing Corp. Carol Stream III., U.S.A..

The presence of 5% of [(1R,3S)-3-Isopropyl-1-methylcyclopentyl]methanol confers to this formula a creamy, lily-of-the-valley aspect.

### EXAMPLE 8

### Floral Composition for Soap

| Ingredient* | Parts per weight |
|---|---|
| Agrumex | 100 |
| Benzophenone | 60 |
| Benzyl acetate | 55 |
| Bergamot base | 80 |
| 4-t-Butylcyclohexyl acetate | 150 |
| Diphenyl oxide | 20 |
| Dipropylene glycol (DPG) | 78 |
| Ebanol | 20 |
| Hydroxycitronellal | 200 |
| Jasmine base | 80 |
| Methyl Phenylacetate | 2 |
| Nerol | 20 |
| Phenylpropyl alcohol | 40 |
| Rose base | 100 |
| Rhodinol | 65 |
| Sandela | 30 |
| Silvial | 100 |
| [(1R,3S)-3-Isopropyl-1-methylcyclopentyl]methanol | 50 |
| Total | 1250 |

*for chemical names see Flavor and Fragrance Materials - 2003, Allured Publishing Corp. Carol Stream III., U.S.A..

[(1R,3S)-3-Isopropyl-1-methylcyclopentyl]methanol makes this lily-of-the-valley fragrance velvety and rich.

1. A method for using a compound as a fragrance, the method comprising:
using a compound of formula Ia and an enantiomer thereof as a fragrance wherein the compound of formula Ia is described by the chemical structure: 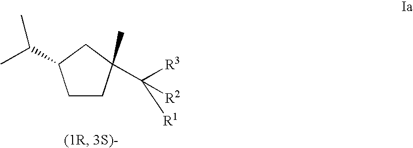
wherein
R¹ is at least one of hydrogen or methyl;
R² is hydrogen; and
R³ is hydroxyl; or
R² and R³ form together with the carbon atom to which they are attached a carbonyl group.

2. The method according to claim 1, wherein the compound of formula Ia and the enantiomer thereof are at least one of [(1R,3S)-3-isopropyl-1-methylcyclopentyl]methanol, [(1S,3R)-3-isopropyl-1-methylcyclopentyl]methanol, 1-[(1R,3S)-3-isopropyl-1-methylcyclopentyl]ethanone, 1-[(1S,3R)-3-isopropyl-1-methylcyclopentyl]ethanone, 1-[(1R,3S)-3-isopropyl-1-methylcyclopentyl]ethanol or 1-[(1S,3R)-3-isopropyl-1-methylcyclopentyl]ethanol.

3. A method for using a compound as a fragrance, the method comprising:
using a compound of formula I enriched in an enantiomer having formula Ia, as a fragrance, wherein the compound of formula I is described by the chemical structure: 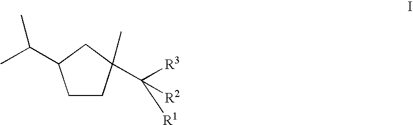
wherein the enantiomer having formula Ia is described by the chemical structure: 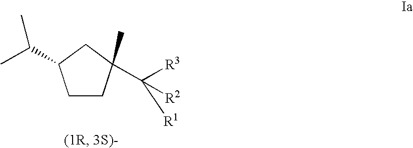
wherein
R¹ is at least least one of hydrogen or methyl;
R² is hydrogen; and
R³ is hydroxyl; or
R² and R³ form together with the carbon atom to which they are attached a carbonyl group.

4. A method for using a compound as a fragrance, the method comprising:
using a compound of formula I enriched in the enantiomer having formula Ib, as a fragrance,
wherein the compound of formula I is described by the chemical structure: 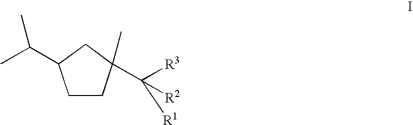
wherein the enantiomer having formula Ib is described by the chemical structure: 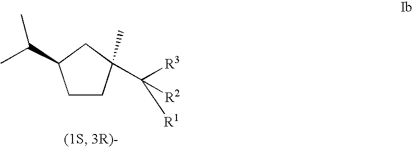
wherein
R¹ is at least one of hydrogen or methyl;
R² is hydrogen; and
R³ is hydroxyl; or
R² and R³ form together with the carbon atom to which they are attached a carbonyl group.

5. A method for using a compound as a fragrance, the method comprising:
using at least one compound of formula I, Ia or Ib in a fragrance application, wherein the compound of formula I is described by the chemical structure: 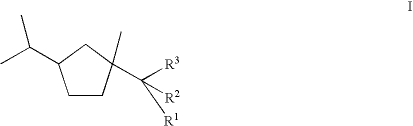
wherein the compound of formula Ia is described by the chemical structure: 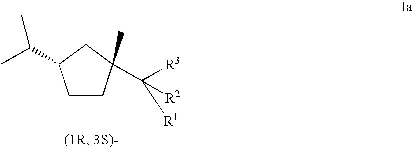
wherein the compound of formula Ib is described by the chemical structure: 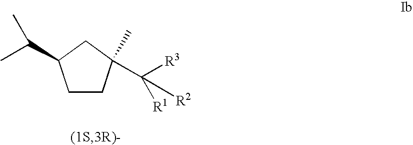
wherein
R¹ is at least one of hydrogen or methyl;
R² is hydrogen; and
R³ is hydroxyl; or
R² and R³ form together with the carbon atom to which they are attached a carbonyl group.

6. A fragrance application comprising a compound of at least one of formula I, Ia, or Ib wherein the compound of formula I is described by the chemical structure: 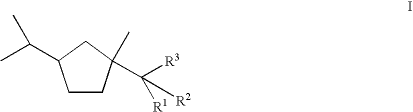
wherein the compound of formula Ia is described by the chemical structure: 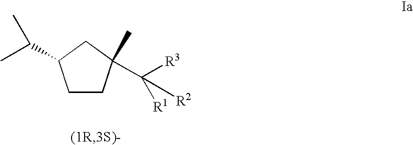
wherein the compound of formula Ib is described by the chemical structure: 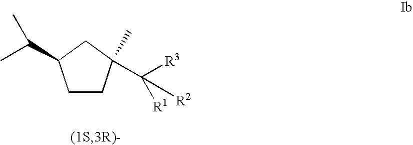
wherein
R¹ is at least one of hydrogen or methyl;
R² is hydrogen; and
R³ is hydroxyl; or
R² and R³ form together with the carbon atom to which they are attached a carbonyl group.

7. The fragrance application according to claim 6, wherein the fragrance application is at least one of perfume, household product, laundry product, body care products or cosmetic product.

8. A method of manufacturing a fragrance application, the method comprising:
incorporating a compound of formula Ia or its enantiomer, wherein the compound of formula Ia is described by the chemical structure: 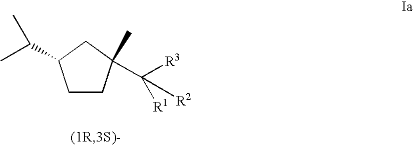
wherein
R¹ is at least one of hydrogen or methyl;
R² is hydrogen; and
R³ is hydroxyl; or
R² and R³ form together with the carbon atom to which they are attached a carbonyl group.

9. A compound comprising:
a compound of formula Ia, wherein the compound of formula Ia is described by the chemical structure: 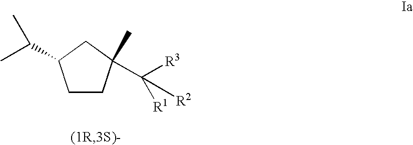
wherein
R¹ is at least one of hydrogen or methyl;
R² is hydrogen; and
R³ is hydroxyl; or
R² and R³ form together with the carbon atom to which they are attached a carbonyl group.

10. A compound comprising:
a compound of formula Ib, wherein the compound of formula Ib is described by the chemical structure: 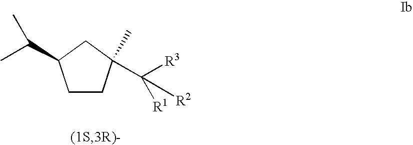
wherein
R¹ is at least one of hydrogen or methyl;
R² is hydrogen; and
R³ is hydroxyl; or
R² and R³ form together with the carbon atom to which they are attached a carbonyl group.
